(19) United States
(12) Patent Application Publication
(10) Pub. No.: US 2023/0267433 A1
(43) Pub. Date: Aug. 24, 2023

(54) Digital Marketplace for Selling Digital Assets

(71) Applicants: Stone Melet, San Francisco, CA (US); Richard Cosentino, Scotts Valley, CA (US)

(72) Inventors: Stone Melet, San Francisco, CA (US); Richard Cosentino, Scotts Valley, CA (US)

(21) Appl. No.: 18/171,323

(22) Filed: Feb. 17, 2023

Related U.S. Application Data
(60) Provisional application No. 63/311,942, filed on Feb. 18, 2022.

(51) Int. Cl. G06Q 20/12; G06Q 20/10; G06Q 20/36; G06Q 20/38

(52) U.S. Cl. CPC G06Q 20/1235; G06Q 20/10; G06Q 20/3672; G06Q 20/389

(57) ABSTRACT

Digital marketplaces for selling digital assets, such as non-fungible tokens (NFTs). In embodiments, the digital asset is offered for sale subject to a trigger condition. In embodiments, responsive to the trigger condition being met, a digital token, such as an NFT, is generated for the digital asset and ownership is transferred.

### CROSS-REFERENCE TO RELATED APPLICATIONS

This application claims the benefit and priority under 35 U.S.C 119(e) of U.S. Provisional Application No. 63/311,942, filed Feb. 18, 2022, the entire contents of which are incorporated by reference herein in its entirety.

### BACKGROUND

### A. Technical Field

The present invention pertains generally to a marketplace for selling digital assets, such as a non-fungible tokens (NFTs).

### B. Background of the Invention

Non-fungible tokens (NFTs) have become a popular way to authenticate the ownership of digital assets, such as photos, videos, artwork, audio recordings, etc. NFTs also provide a convenient way to buy and sell digital assets. The popularity of these tokens is increasing at a rapid pace and entrepreneurs are coming up with new ways to use NFTs on a daily basis.

### BRIEF DESCRIPTION OF DRAWINGS

Reference will be made to embodiments of the invention, examples of which may be illustrated in the accompanying figures. These figures are intended to be illustrative, not limiting. Although the invention is generally described in the context of these embodiments, it should be understood that it is not intended to limit the scope of the invention to these particular embodiments.

FIG. 1 is a diagram of a network environment in which the marketplace operates in embodiments.

FIG. 2 is a flow diagram of a marketplace transaction 200 according to embodiments of the invention.

FIG. 3 is a flow diagram of a marketplace transaction 300 according to embodiments of the invention.

FIG. 4 is a flow diagram of a marketplace transaction 400 according to embodiments of the invention.

### DETAILED DESCRIPTION

In the following description, for purposes of explanation, specific details are set forth in order to provide an understanding of the invention. It will be apparent, however, to one skilled in the art that the invention can be practiced without these details. Furthermore, one skilled in the art will recognize that embodiments of the present invention, described below, may be constructed/implemented in a variety of ways. Accordingly, the figures described herein are illustrative of specific embodiments of the invention and are meant to avoid obscuring the invention.

Reference in the specification to “one embodiment,” “preferred embodiment,” “an embodiment,” or “embodiments” means that a particular feature, structure, characteristic, or function described in connection with the embodiment is included in at least one embodiment of the invention and may be in more than one embodiment. The appearances of the phrases “in one embodiment,” “in an embodiment,” or “in embodiments” in various places in the specification are not necessarily all referring to the same embodiment or embodiments.

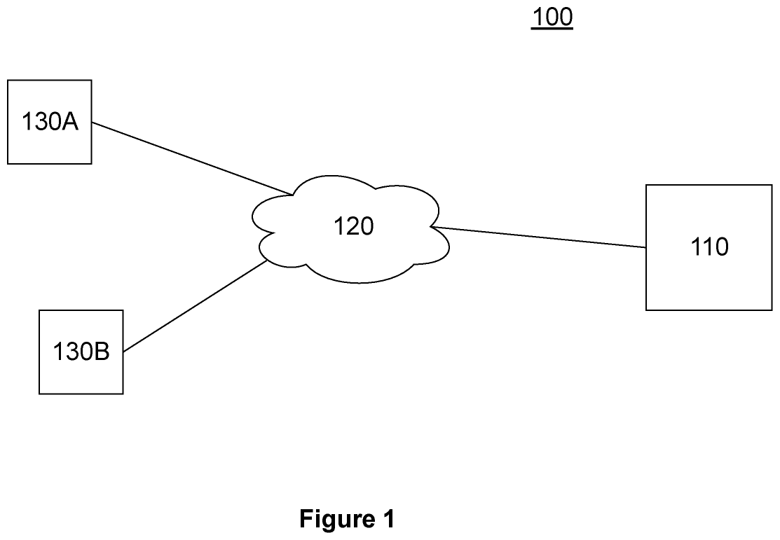

A marketplace for selling digital assets, such as NFTs, is disclosed herein. FIG. 1 is a diagram of a network environment 100 in which the marketplace operates in embodiments. The network environment 100 includes a datacenter 110 coupled to a plurality of clients 130 over a network 120, such as the Internet. In embodiments, datacenter 110 is a system comprised of one or more servers that store, process and disseminate data and applications. In embodiments, the servers may be located in a single location or may be distributed across multiple locations coupled by a network, such as the Internet.

In embodiments, the one or more servers include memory that stores software instructions that when executed by one or more processors, implement one or more applications, such as the marketplace described herein. In embodiments, the memory comprises volatile memory (e.g., dynamic random access memory (DRAM)) and/or non-volatile memory (e.g., flash memory, hard disk drives, etc.). In embodiments, the one or more processors comprise central processing units (CPUs), graphics processing units (GPUs), accelerators or other processing devices that are known to one skilled in the art. Example CPUs include, but are not limited to, those based on the X86 architecture, ARM instruction set architecture or other architectures that are well known to those skilled in the art.

In embodiments, the datacenter 110 and clients 130 connect with network 120 over wired and/or wireless connections as is well known in the art. In embodiments, the clients 130 and servers transmit data to and receive data from each other via network protocols that are well known in the art. In embodiments, clients 130 may be any type of computing device, including mobile devices (smartphones, tablets, etc.) desktop computers, laptops, etc.

In embodiments, datacenter 110 includes software that implements a marketplace application to store, display and transact (e.g., sell) digital assets. For example, software code stored in the memory of datacenter 110, when executed, configures the datacenter 110 to provide a user interface to various clients 130. In embodiments, the client devices 130 access the user interface via a web browser, mobile application or any other means known to those skilled in the art. Through the user interface, users of the client devices 130 can browse and request to purchase the digital assets displayed in the user interface. In embodiments, the digital assets are stored in the memory located within datacenter 110. In embodiments, the digital assets include, but are not limited to photos, artwork, electronic documents, audio files or NFTs that include photos, artwork, electronic documents, audio files or other digital content as is well known in the art.

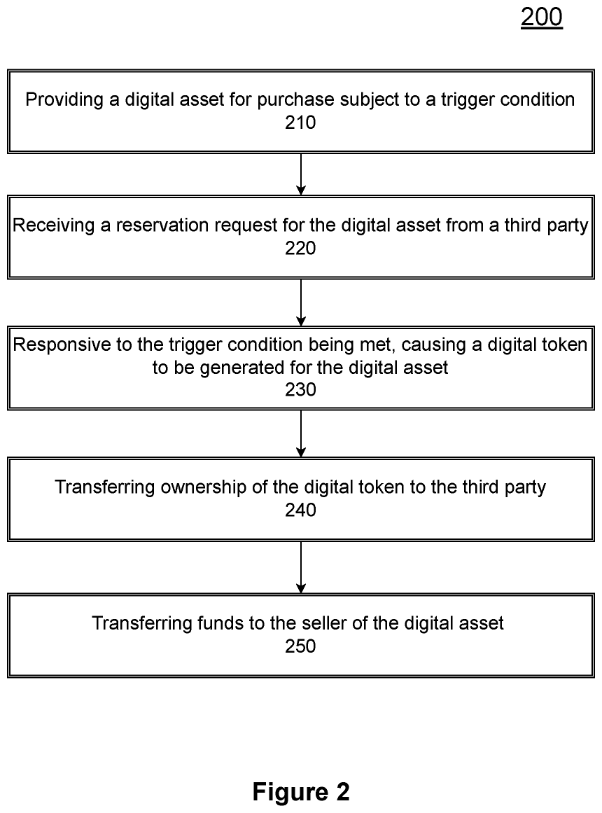

FIG. 2 is a flow diagram of a marketplace transaction 200 according to embodiments of the invention. In embodiments, the transaction is performed by software executing on one or more processors of one or more servers as discussed previously. In embodiments, the transaction comprises providing 210 a digital asset that is available for purchase subject to a trigger condition. For example, a processor of a server may transmit one or more pre-NFT digital assets over a network, such as the Internet, for display on a user client device as is well known in the art. In embodiments, a pre-NFT is a digital asset that will be sold as an NFT, but which has not yet been minted. This means that the asset has not yet been recorded to a blockchain. In embodiments, users view the assets for sale via a website or application interface which displays the digital assets provided by the server.

In embodiments, the transaction comprises receiving 220 a reservation request for the digital asset (e.g., pre-NFT) from a third party. In embodiments, software executing on a processor of a server may receive the reservation request over a network connection, such as via an Internet protocol as is well known in the art. For example, the third party may be a user who selects a “Buy” button associated with the digital asset displayed in a web browser or application interface on the user's client device. This signifies the user's willingness to purchase the digital asset when the trigger condition is met. In embodiments, the reservation request includes the funds for the advertised purchase price of the digital asset. In embodiments, the funds may be transferred or received via electronic means, such as via bank/wire transfer, credit card transactions, or peer-to-peer transfers (e.g., Venmo, PayPal, Zelle, etc.) or non-electronic means (e.g., check, cash, etc.) that are well known in the art. In embodiments, the marketplace maintains the received funds in escrow subject to the trigger condition. If the trigger condition fails to occur, the funds are refunded to the user. In other embodiments, the reservation request is simply an agreement to purchase the digital asset when the trigger condition occurs. In this example, when the trigger condition is met, the funds are immediately deducted from the user's credit card, bank account or other means of payment.

In embodiments, the transaction comprises, responsive to the trigger condition being met, causing 230 a digital token to be generated for the digital asset. In embodiments, an NFT is generated for the digital asset. For example, in embodiments, software executing on a processor of a marketplace server causes an NFT associated with the digital asset to be generated by initiating the process to mint or record the NFT on a blockchain, such as the Ethereum blockchain. In embodiments, this portion of the transaction is optional. For example, if the digital asset offered for sale is already a digital token, such as an NFT, there is no need to cause a digital token to be generated.

In embodiments, the transaction comprises transferring 240 ownership of the digital token to the third party who placed the reservation request. In embodiments, ownership is transferred by software executing on a processor of a server responsive to the trigger condition being met. In embodiments, ownership is transferred as part of the NFT minting/recording process, which identifies the third party as the owner of the NFT. In other examples, the NFT is generated for the digital asset assigning the seller of the digital asset as the owner and then a change of ownership is recorded to the respective blockchain. In embodiments, the transferring of ownership includes providing the third party with information regarding the transfer of ownership, a digital file, etc.

In embodiments, the transaction comprises transferring 250 funds to the seller of the digital asset. In embodiments, software executing on a processor of a server transfers the funds responsive to the trigger condition being met. In embodiments, the seller is the person, entity, etc. who had an ownership interest in the digital asset at the time the asset was made available for purchase subject to the trigger condition. In embodiments, the seller of the digital asset receives a portion of the funds paid for the digital asset and the marketplace receives a portion of the funds paid for the digital asset.

As discussed above, one of the unique features of the marketplace transactions is that the sale of the digital asset does not occur until the trigger condition is met. Thus, in embodiments, the marketplace transactions are used to influence behavior. As an example, five-star rated athletes are highly sought after by Division I colleges and universities. Traditionally, fans have had little ability to influence the decision of these athletes to sign with their favorite school. However, using the disclosed marketplace and transactions, an athlete can upload a digital asset specifically tailored to each of the schools that he/she is considering attending to the marketplace. For example, if the athlete has narrowed his/her choice to Alabama, Florida or UCLA, the athlete may upload three photos (digital assets) of himself/herself wearing a jersey from each of the three respective schools. In embodiments, the trigger condition is that the athlete selects the school associated with the digital asset and/or plays a particular sport for that school.

While the example provided relates to an athlete's decision with respect to selecting a school to attend, the same can be applied to professional sports as well.

Fans from each of the respective schools provide reservation requests for the digital asset associated with the respective school. For example, assuming the digital asset associated with each school costs $40, fans could purchase one or more copies of the asset, each of which would be minted as a separate NFT if/when the trigger condition is met. Continuing the example above, assume that Alabama fans make reservation requests totaling $40,000, UCLA fans make reservations requests totaling $20,000 and Florida fans make reservation requests totaling $4000. In embodiments, a portion of the funds from the sale of the digital asset are split between the marketplace and the athlete. Thus, the amounts fans from the various schools are willing to pay for the respective digital asset may influence the athlete's decision to attend that school. In this example, the athlete may be influenced to select Alabama over UCLA and Florida since he/she would receive a greater amount from the sale of the Alabama-specific NFT.

One skilled in the art will recognize that any number of trigger conditions may be associated with the sale of a digital asset. Further examples include, but are not limited to, 1) signing a letter of intent to play for a particular school, 2) an athlete's decision to stay in school and continue to play for the sports team rather than entering a draft for a professional league or joining a professional team, 3) an athlete's decision to stay at a school rather than transfer to another school, 4) the hiring or firing of an employee (e.g., a coach) by an entity (e.g., collegiate school, professional sports team, etc.).

In embodiments, the seller of a digital asset designates a third party as a beneficiary to receive the funds associated with the sale of the digital asset when the trigger condition is met. For example, many college football coaches have contracts that guarantee their salary or provide for large payouts in the event they are fired before the term of the contract has expired. Such contracts can be a deterrent to firing a coach whose team is not performing as expected. In embodiments, a fan can create a digital asset (e.g., NFT) for sale subject to the trigger condition that the coach is fired. In embodiments, the fan designates the school as the beneficiary of the funds received when the trigger condition is met. This allows fans to contribute to the coach's contract buyout, thus reducing the burden on the school's budget from firing the coach.

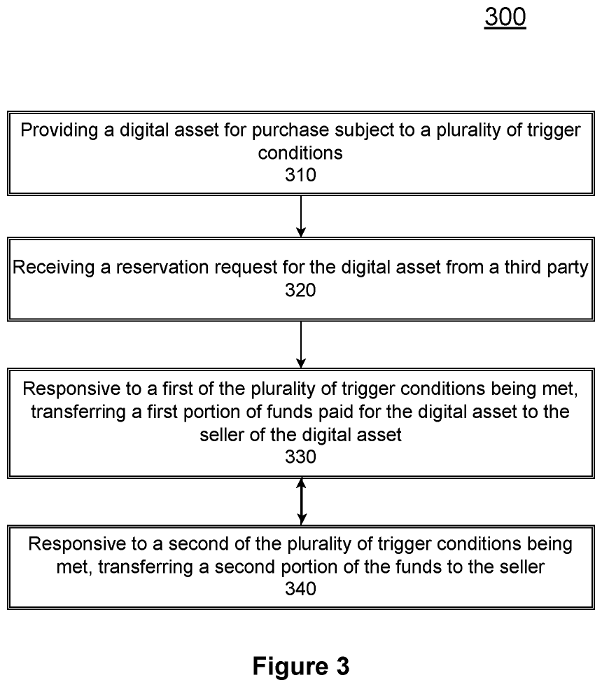

In embodiments, there are multiple trigger conditions associated with the sale of a digital asset, such as an NFT. For example, FIG. 3 is a flow diagram of a marketplace transaction 300 according to embodiments of the invention that is performed by software executing on one or more processors of one or more servers as discussed previously. In embodiments, the transaction comprises providing 310 a digital asset for purchase subject to a plurality of trigger conditions. Returning to the example above, the $40 fans paid for an athlete's NFT may be spread over the four years of eligibility to play collegiate sports for the school. In this example, there are up to four trigger conditions for the NFT. The first trigger condition is met when the athlete enrolls in his/her first year of classes at the school. The second trigger condition is met when the athlete enrolls in his/her second year of classes at the school and so on.

In embodiments, the transaction comprises receiving 320 a reservation request for the digital asset from a third party. As discussed above with respect to FIG. 2, the reservation request may include the funds to purchase the digital asset or include an authorization to deduct funds from a credit card, bank account, etc. when one or more of the trigger conditions are met.

In embodiments, the transaction comprises, responsive to a first of the plurality of trigger conditions being met, transferring 330 a first portion of funds paid for the digital asset to the seller of the digital asset. Returning to the example above, the athlete receives a quarter of the funds paid for the digital asset each year he/she attends the school and plays the particular sport. Thus, upon enrolling in first year classes (first trigger condition), the seller receives a quarter of the funds paid for the digital asset. In embodiments, the transaction may further comprise, causing a digital token (e.g., NFT) to be generated for the digital asset when the first trigger condition is met.

In embodiments, the transaction further comprises, responsive to a second of the plurality of trigger conditions being met, transferring 340 a second portion of the funds to the seller. Again, per the example above, enrolling in the second year of classes at the school satisfies the second trigger condition which results in a second quarter of the funds being distributed to the seller.

In embodiments, if the second or later trigger conditions are not met, the third party keeps ownership of the digital asset and also receives a refund of the remaining funds. For example, if the athlete transfers after the first school year, the second, third and fourth trigger conditions would not be met. In this case, three quarters of the funds are returned to the third-party purchaser of the digital asset, who maintains ownership of the digital asset for the reduced price.

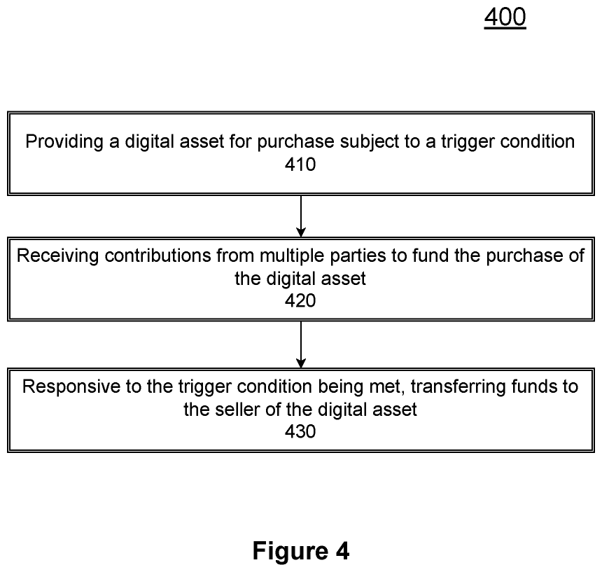

FIG. 4 is a flow diagram of a marketplace transaction 400 according to embodiments of the invention that is performed by software executing on one or more processors of one or more servers as discussed previously. In embodiments, the transaction comprises providing 410 a digital asset for purchase subject to a trigger condition. In embodiments, the digital asset may be a minted NFT or a pre-NFT digital asset as discussed previously.

In embodiments, the transaction comprises receiving 420 contributions from multiple parties to fund the purchase of the digital asset. For example, in embodiments, software executing on one or more processors of one or more servers receive reservation requests from multiple third parties for a single digital asset. Thus, rather than providing each fan with their own NFT for a specified price, fans may simply pool their contributions to purchase a single digital asset, such as an NFT. Returning to the example provided above, multiple reservation requests are received from Alabama fans, resulting in a pool of money to purchase the Alabama-specific NFT. Similarly, fans from UCLA pool their money to purchase the UCLA-specific NFT. Again, this enables fans to use money to influence an athlete's choice of school.

In embodiments, responsive to the trigger condition being met, the transaction comprises transferring 430 funds to the seller of the digital asset. In embodiments, software executing on one or more processors transfers funds to the seller or beneficiary as described previously. Returning to the example above, when the athlete makes his/her decision on the school to attend, the trigger condition is met and the digital asset (e.g., NFT) for the selected school is sold to the fans that contributed to the purchase. In embodiments, the athlete receives a portion of the funds contributed to the purchase of the digital asset minus a percentage of the funds which goes to the marketplace. In this scenario, ownership of the NFT may be divided amongst the various fans based on the percentage of each fan's contribution to the total. Alternatively, the ownership may simply pass to a third party, such as the selected school itself.

In embodiments, the transaction 400 also comprises causing a digital token to be generated for the digital asset responsive to the trigger condition being met. For example, if the digital asset is a pre-NFT digital asset, software executing on a processor of a server may cause an NFT to be minted and/or recorded on a blockchain as discussed previously.

While many of the examples provided above reference an NFT as the digital asset, one skilled in the art will recognize that the present invention is not limited to NFTs. Other forms of digital assets sold through the marketplace are contemplated and fall within the scope of the invention. Similarly, while many of the trigger conditions described above relate to recruiting athletes, one skilled in the art will recognize that the present invention is not limited to sports and/or the recruitment of athletes. Other trigger conditions are contemplated and fall within the scope of the present invention.

It will be appreciated by those skilled in the art that the preceding examples and embodiments are exemplary and not limiting to the scope of the present invention. It is intended that all permutations, enhancements, equivalents, combinations, and improvements thereto that are apparent to those skilled in the art upon a reading of the specification and a study of the drawings are included within the true spirit and scope of the present invention.

What is claimed is:

1. A system comprising one or more servers for hosting a marketplace for selling digital assets, comprising:
one or more processors;
one or more memory devices configured to store software instructions that, when executed, cause the one or more processors to:
provide a first digital asset for purchase subject to a first trigger condition;
provide a second digital asset for purchase subject to a second trigger condition, wherein the first and second trigger conditions are mutually exclusive;
receive a first reservation request for the first digital asset from a first potential purchaser;
receive a second reservation request for the second digital asset from a second potential purchaser;
responsive to the first trigger condition being met, transfer at least a portion of funds associated with the first reservation request to a beneficiary associated with a sale of the digital asset.

2. The system of claim 1, wherein the one or more memory devices further store software instructions that, when executed, cause the one or more processors to:
transfer ownership of the digital asset to the first potential purchaser.

3. The system of claim 1, wherein the one or more memory devices further store software instructions that, when executed, cause the one or more processors to:
cause a digital token to be generated for the digital asset responsive to the first trigger condition being met.

4. The system of claim 3, wherein the digital token is a non-fungible token (NFT) for the digital asset that is minted on a blockchain.

5. The system of claim 1, wherein the first and second trigger conditions are mutually exclusive outcomes associated with a decision by an individual.

6. The system of claim 5, wherein the individual is an athlete and the decision is that the athlete will play for a particular sports team.

7. A method for selling digital assets through a marketplace available via a network, comprising:
providing a first digital asset for purchase subject to a first trigger condition;
providing a second digital asset for purchase subject to a second trigger condition, wherein the first and second trigger conditions are mutually exclusive;
receiving a first reservation request for the first digital asset from a first potential purchaser;
receiving a second reservation request for the second digital asset from a second potential purchaser;
responsive to the first trigger condition being met, transferring at least a portion of funds associated with the first reservation request to a beneficiary associated with a sale of the digital asset.

8. The method of claim 7, further comprising:
transferring ownership of the digital asset to the first potential purchaser.

9. The method of claim 7, further comprising:
causing a digital token to be generated for the digital asset responsive to the first trigger condition being met.

10. The method of claim 9, wherein the digital token is a non-fungible token (NFT) for the digital asset that is minted on a blockchain.

11. The method of claim 7, wherein the first and second trigger conditions are mutually exclusive outcomes associated with a decision by an individual.

12. The method of claim 11, wherein the individual is an athlete and the decision is that the athlete will play for a particular sports team.

13. A method for selling digital assets through a marketplace available via a network comprising:
providing a digital asset for purchase subject to a trigger condition;
receiving a reservation request for the digital asset from a third party; and
responsive to the trigger condition being met, transferring funds to a beneficiary associated with a sale of the digital asset.

14. The method of claim 13, further comprising:
transferring ownership of the digital asset to the third party.

15. The method of claim 13, further comprising: causing a digital token to be generated for the digital asset responsive to the trigger condition being met.

16. The method of claim 15, wherein the digital token is a non-fungible token (NFT) for the digital asset that is minted on a blockchain.

17. The method of claim 13, wherein the reservation request includes funds to purchase the digital asset.

18. The method of claim 13, wherein the digital asset is a non-fungible token (NFT).

19. The method of claim 13, wherein the beneficiary of the sale of the digital asset is an athlete.

20. The method of claim 13, wherein the trigger condition is that a particular athlete plays for a particular sports team.
